(19) United States
(12) Patent Application Publication
(10) Pub. No.: US 2008/0241722 A1
(43) Pub. Date: Oct. 2, 2008

(54) Mixed Crystals Comprising C.I. Pigment Red 170 Derivatives

(76) Inventors: Martin Ulrich Schmidt, Frankfurt am Main (DE); Hans Joachim Metz, Darmstadt (DE); Andreas Wacker, Mannheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/568,716

(22) PCT Filed: Aug. 4, 2004
(86) PCT No.: PCT/EP2004/008724

§ 371 Date: Jun. 9, 2008

(30) Foreign Application Priority Data
Aug. 19, 2003 (DE) 103 38 059.0

(51) Int. Cl. C09D 11/02; C08K 5/00; G03G 9/00; G02B 5/23

(52) U.S. Cl. 430/105; 106/499; 106/31.75; 252/586

(57) ABSTRACT

A mixed crystal of C.I. Pigment Red 170 and one or more of the compounds of the formula (1)

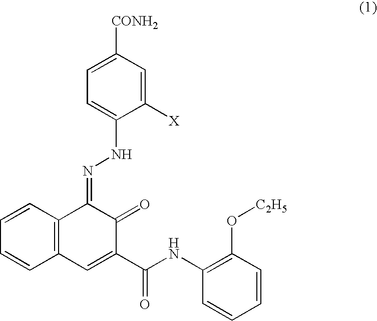

wherein
X has the definition F, Cl, Br, methyl or nitro. The novel mixed crystals have better light-fastness and weather resistance than unsubstituted C.I. Pigment Red 170.

The present invention relates to new mixed crystals based on C.I. Pigment Red 170 and derivatives thereof, and to processes for preparing them.

C.I. Pigment Red 170 (formula (1), X═H) is described in DE 1 228 731. The alpha, beta and gamma-phases are described in DE 2 043 482.

In paints and plastics C.I. Pigment. Red 170 has good, but not perfect, light fastness and weather fastness properties.

A number of mixed crystals with C.I. Pigment Red 170 have been described. For example, a mixed crystal of C.I. Pigment Red 170 and C.I. Pigment Red 266 (which contains a methoxy group instead of the ethoxy group) is known as “C.I. Pigment Red 210”.

The light fastness and weather fastness of C.I. Pigment Red 210 however, are poorer than those of C.I. Pigment Red 170 itself.

An aim of the present invention was to prepare red azo pigments which have better light fastness and weather fastness properties that the aforementioned C.I. Pigment Red 170.

It has been found that the mixed crystals of C.I. Pigment Red 170 and derivatives of the formula (1), defined below, surprisingly solve this problem.

The present invention provides mixed crystals of C.I. Pigment Red 170 and one or more of the compounds of the formula (1)

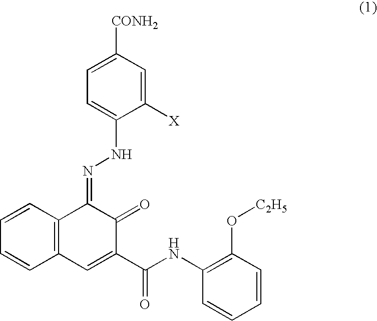

wherein

X has the definition F, Cl, Br, methyl or nitro.

The compounds (1) with X═F are referred to below as “F-P.R.170”; with X═Cl, as “Cl-P.R.170; with X═Br as “Br-P.R.170”; with X=methyl, as “methyl-P.R.170”; with X=nitro as “nitro-P.R.170”; and with X═H, as “P.R.170”.

The formula (1) is to be understood as an idealized representation and it also embraces the corresponding tautomeric forms and also the possible cis/trans isomers of each tautomeric form.

Mixed crystals for the purposes of the present invention also comprehend solid solutions. The properties of the mixed crystals differ from the properties both of the individual components and of the physical mixtures of the individual components. In particular the X-ray powder diagrams of the mixed crystals differ from the sum of the powder diagrams of the individual compounds.

The compounds of the formula (1) as such, and also processes for their preparation, are described in the as yet unpublished German patent application 102 24 279.8. Both methyl-P.R.170 and nitro-P.R.170 occur in a number of different phases.

The mixed crystals may contain between 0.1% and 99.9% by weight, preferably between 1 and 99% by weight, in particular between 80 and 99% by weight, of C.I. Pigment Red 170, and between 99.9 and 0.1% by weight, preferably between 99 and 1% by weight, in particular between 20 and 1% by weight, of a compound of the formula (1) or of any desired mixture of two of more, e.g., 2 or 3, compounds of the formula (1).

The proportions of the individual components in the mixed crystals of the invention are, for each individual component, preferably between 1 and 99 mol %, more preferably between 10 and 90 mol %. Preferred binary mixed crystals are composed of P.R.170 and one of the compounds of the formula (1), particularly those with X═Cl or methyl, preferably in a molar proportion of 100:1 to 3:1, in particular of 50:1 to 10:1.

The mixed crystals may occur in different crystal polymorphs. For example, the mixed crystals may be isotypic with the alpha, beta or gamma phase of C.I. Pigment Red 170. The isotypy as well is found from X-ray powder diagrams. In case of doubt, a mixed crystal series with different concentrations is prepared, in order to ascertain whether the line positions and line intensities change continuously with the composition.

The mixed crystals are distinguished by red hues, high color strengths, and very good light fastness and weather fastness properties.

The mixed crystals of the invention can be prepared, for example, by cosynthesis or by joint recrystallization, grinding and/or finishing of the various individual compounds.

The pigments of the invention can be prepared, for example by diazotizing a mixture of 1-aminobenzene-4-carboxamide (formula (2), X═H) and one or more amines of the formula (2)

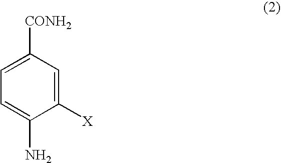

where X has the definition F, Cl, Br, methyl or nitro,

and subsequently coupling the product with the compound of the formula (3)

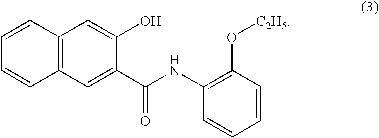

The mixed crystal pigments of the invention can also be prepared, for example, by separately diazotizing 1-aminobenzene-4-carboxamide (formula (2), X═H) and one or more amines of the formula (2), then mixing the diazonium salts, and subsequently coupling the mixture with the compound of the formula (3).

The mixed crystal pigments of the invention can also be prepared by coupling at least one diazotized amine of the formula (2) with 1-(2′,3′-oxynaphthoylamino)-2-ethoxybenzene of the formula (3) in the presence of ready-prepared C.I. Pigment Red 170.

The mixed crystal pigments of the invention can also be prepared by coupling diazotized 1-aminobenzene-4-carboxamide with 1-(2′,3′-oxynaphthoylamino)-2-ethoxybenzene of the formula (3) in the presence of at least one compound of the formula (1).

Suitable for the diazotization reaction are alkali metal nitrites or the alkyl nitrites of short-chain alkanes, together with strong mineral acids. Of particular suitability are sodium nitrite and hydrochloric acid. The reaction can be carried out in a temperature range from −5° C. to +30° C., preferably between 0° C. and 10° C. Although not necessary, it is possible for nonionic, anionic or cationic surfactants to be present during the diazotization. Where appropriate it is also possible to use further auxiliaries, such as natural or synthetic resins or resin derivatives.

Coupling is possible by the direct or indirect method but is preferably accomplished indirectly—that is, the coupling component is added to the already-introduced diazonium salts. The coupling reaction can be carried out in a temperature range between −5° C. and 80° C., preferably between 5° C. and 25° C., and at a pH between 4 and 14, in particular between 9 and 12. The azo coupling reaction takes place preferably in aqueous solution or suspension, although organic solvents can also be used, on their own or as a mixture with water.

The addition of alkali-soluble resinous auxiliaries or mixtures thereof during or after coupling, and also before or during laking, improves the dispersibility of the mixed crystal pigments of the invention. Advantageously the resinous auxiliaries or mixtures thereof are used in the form of their aqueous-alkaline solutions. Suitable resinous auxiliaries include natural and synthetic resins. Advantageous representatives include rosin, disproportionated or hydrogenated rosin, and also rosin derivatives. Preference is given to natural resin acids, such as abietic acid, dihydroabietic acid, tetrahydroabietic acid, levopimaric acid, dextropimaric acid, and isodextropimaric acid, such as are present in commercially available rosin varieties. Particular preference is given to the commercially available resin Rosin N, which contains the resin acids abietic acid, dehydroabietic acid, neoabietic acid, palustric acid, isopimaric acid, pimaric acid and sandaracopimaric acid, or to a commercial product which is equivalent to Rosin N. As well as the enumerated resins and their derivatives, it is also possible to use alkyd resins or synthetic hydrocarbon resins. The stated resins are added to the reaction mixture preferably following the coupling reaction.

The coupling component is generally used in a slight excess over the diazonium compound; preference is given to reacting one equivalent of diazo component with 1.001 to 1.10 equivalents of the coupling component.

After the coupling, the compounds of the invention are preferably subjected to a heat treatment in aqueous, aqueous organic or organic medium at temperatures between 80 and 200° C., where appropriate under superatmospheric pressure, and advantageously for 1 to 6 hours, in particular in the presence of the abovementioned resinous auxiliaries. As described above, specific crystal phases may arise or phase transformations may occur. The pigment suspensions obtained can then be filtered in conventional manner and the presscake can be washed salt-free with water, dried and ground.

Depending on the desired field of application it may also be sensible first to subject the as-synthesized pigment to mechanical fine division. Fine division may be accomplished by wet or dry grinding or kneading. Grinding or kneading may then be followed by treatment with a solvent, with water or with a solvent/water mixture. To facilitate the formation of mixed crystals, to stabilize the mixed crystals, to enhance the coloristic properties, and to obtain specific coloristic effects it is possible, at any desired points in the process, to add pigment dispersants, surface-active agents, defoamers, extenders or other adjuvants. It is also possible to use mixtures of these additives. The additives may be added all at once or in two or more portions. The additives may be added at any point in the synthesis or in the various aftertreatments, or after the aftertreatments. The most appropriate moment must be determined beforehand by means of range finding tests.

It is also possible to carry out one or more of the stated process steps for preparing the mixed crystals of the invention in a microreactor, as described in EP-A-1 257 602.

The mixed crystals of the invention can also be obtained by mixing P.R.170 and one or more compounds of the formula (1) with subsequent treatment, for example kneading, grinding, recrystallization and/or heating, in water and/or solvent, for example, and also under superatmospheric pressure. For example, P.R.170 in the alpha phase can be mixed with 10 mol % of methyl-P.R.170 in the alpha phase, and the mixture can be heated in water at 130° C. to 160° C. to give a mixed crystal in the gamma phase. Mixed crystals of C.I. Pigment Red 170 and methyl-P.R.170 in the alpha phase are produced, for example, by diazotizing a mixture of 0.1% to 99.9% by weight of 1-aminobenzene-4-carboxamide and 99.9% to 0.1% by weight of 1-amino-2-methylbenzene-4-carboxamide, and coupling the diazonium salt with 1-(2′,3′-oxynaphthoylamino)-2-ethoxybenzene without subsequently heating the suspension. The mixed crystals which result form a continuous mixed-crystal series, over the entire compositional range, with the alpha phase of P.R.170 and the alpha phase of methyl-P.R.170.

Mixed crystals of C.I. Pigment Red 170 and methyl-P.R.170 in the beta phase come about, for example, when synthesis and finishing are carried out in accordance with DE 1 228 731, example 4 (diazotization, coupling, addition of resin soap and calcium chloride, 1-hour boiling), and instead of 1-aminobenzene-4-carboxamide, an equimolar mixture of 1-aminobenzene-4-carboxamide and 1-amino-2-methylbenzene-4-carboxamide is used. The resulting mixed crystal is isotypical with the beta phase of P.R.170. In the X-ray powder diagram, the mixed crystal is distinguished by the following characteristic lines (Cu K_{α} radiation, 2 theta values in degrees, measurement accuracy ±0.2°, intensities: vs=very strong, s=strong, m=moderate, w=weak, vw=very weak):

Methyl mixed crystal, beta phase:

| 2 theta: | relative intensity: |
|---|---|
| 7.09 | s |
| 8.36 | m |
| 11.31 | m |
| 12.83 | w |
| 15.10 | w |
| 15.28 | w |
| 17.80 | w |
| 25.33 | vs |
| 28.80 | w |

If, in contrast, the two compounds are synthesized individually by the same process, and the pigments are subsequently mixed, the X-ray powder diagram obtained is as follows:

Methyl mixture:

| 2 theta: | relative intensity: |
|---|---|
| 5.3 | w |
| 7.2 | m |
| 7.7 | s |
| 8.2 | m |
| 8.3 | w |
| 11.4 | m |
| 11.5 | s |
| 12.1 | w |
| 13.7 | m |
| 15.1 | w |
| 15.9 | m |
| 17.9 | w |
| 18.9 | m |
| 23.8 | m |
| 23.9 | m |
| 25.0 | m-s |
| 25.6 | vs |
| 25.7 | m-s |
| 27.1 | m |

Mixed crystals of C.I. Pigment Red 170 and nitro-P.R.170 in the gamma phase, come about, for example, when synthesis and finishing are carried out in accordance with DE 2 043 482, example 1 (diazotization, coupling, 3-hour heating in water at 130° C.), and instead of 1-aminobenzene-4-carboxamide, a mixture of 90 mol % 1-aminobenzene-4-carboxamide and 10 mol % 1-amino-2-nitrobenzene-4-carboxamide is used. The resultant mixed crystal is isotypic with the gamma phase of P.R.170, and is distinguished in the X-ray powder diagram by the following characteristic lines:

Nitro mixed crystal, gamma phase:

| 2 theta: | relative intensity: |
|---|---|
| 7.29 | s |
| 8.84 | w |
| 9.04 | w |
| 11.35 | m |
| 12.98 | m-w |
| 15.36 | m |
| 18.17 | m |
| 20.31 | w |
| 23.50 | w |
| 25.63 | vs |
| 26.06 | m |

Here again the X-ray powder diagram of mixed crystal differs markedly from the X-ray powder diagram of a physical mixture of the individual components.

Depending on the purity of the starting materials, the concentrations, the temperatures and temperature profiles employed, the time profile of the synthesis and of any aftertreatment, the pressure, the presence of impurities or additives, and the presence of seed crystals it is possible for there to be formed alternatively only mixed crystals of a single phase or mixed crystals of different phases, or a mixture of mixed crystals and one or more pure compounds.

The mixed crystals of the invention can be employed for pigmenting high molecular mass organic materials of natural or synthetic origin, such as plastics, resins, varnishes, paints or electrophotographic toners and developers and also inks, including printing inks.

High molecular mass organic materials which can be pigmented using the mixed crystals of the invention are, for example, cellulose ethers and cellulose esters, such as ethylcellulose, nitrocellulose, cellulose acetate or cellulose butyrate, natural resins or synthetic resins, such as addition-polymerization resins or condensation resins, examples being amino resins, especially urea and melamine formaldehyde resins, alkyd resins, acrylic resins, phenolic resins, polycarbonates, polyolefins, such as polystyrene, polyvinyl chloride, polyethylene, polypropylene, polyacrylonitrile, polyacrylic esters, polyamides, polyurethanes or polyesters, rubber, casein, silicone and silicone resins, individually or in mixtures. It is unimportant here whether the aforementioned high molecular mass organic compounds are in the form of plastic masses, melts or in the form of spinning solutions, varnishes, paints or printing inks. Depending on the intended use, it proves advantageous to utilize the compounds of the invention in the form of powders, granules, formulations, flushing pastes, masterbatches or dispersions. Based on the high molecular mass organic material to be pigmented, the compounds of the invention are used in an amount of 0.05% to 30% by weight, preferably 0.1% to 15% by weight.

The mixed crystals of the invention are also suitable for use as colorants in electrophotographic toners and developers, such as, for example, one- or two-component powder toners (also called one- or two-component developers), magnetic toners, liquid toners, latex toners, polymerization toners, and specialty toners.

Typical toner binders are addition-polymerization resins, polyaddition resins and polycondensation resins, such as styrene, styrene-acrylate, styrene-butadiene, acrylate, polyester, and phenolic-epoxy resins, polysulfones, polyurethanes, individually or in combination, and also polyethylene and polypropylene, which may also include further ingredients, such as charge control agents, waxes or flow assistants, or may be modified subsequently with these added ingredients.

The mixed crystals of the invention are additionally suitable for use as colorants in powders and powder coating materials, particularly in triboelectrically or electrokinetically sprayable powder coating materials which are employed to coat the surfaces of articles made, for example, from metal, wood, plastic, glass, ceramic, concrete, textile material, paper or rubber.

As powder coating resins use is made typically of epoxy resins, carboxyl- and hydroxyl-containing polyester resins, polyurethane resins and acrylic resins, together with customary hardeners. Combinations of resins are also employed. For example, epoxy resins are frequently used in combination with carboxyl- and hydroxyl-containing polyester resins. Typical hardener components (depending on the resin system) are, for example, acid anhydrides, imidazoles and also dicyandiamide and the derivatives thereof, masked isocyanates, bisacylurethanes, phenolic resins and melamine resins, triglycidyl isocyanurates, oxazolines and dicarboxylic acids.

The mixed crystals of the invention are additionally useful as colorants in inks, preferably ink-jet inks such as those on an aqueous basis, or non-aqueous basis, for example in microemulsion inks, and in those inks which operate in accordance with the hot-melt process.

Ink-jet inks generally contain a total of 0.5% to 15% by weight, preferably 1.5% to 8% by weight, (calculated on a dry basis) of one or more of the mixed crystals of the invention.

Microemulsion inks are based on organic solvents, water, and, if desired, an additional hydrotropic substance (interface mediator). Microemulsion inks contain 0.5% to 15% by weight, preferably 1.5% to 8% by weight, of one or more of the mixed crystals of the invention, 5% to 99% by weight of water and 0.5% to 94.5% by weight of organic solvent and/or hydrotropic compound.

“Solvent-based” ink-jet inks contain 0.5% to 15% by weight of one or more mixed crystals of the invention, and 85% to 99.5% by weight of organic solvent and/or hydrotropic compounds.

Hot-melt inks are based mostly on waxes, fatty acids, fatty alcohols or sulfonamides which are solid at room temperature and liquefy on heating, the preferred melting range being between about 60° C. and about 140° C. Hot-melt ink-jet inks are composed, for example, essentially of 20% to 90% by weight of wax and 1% to 10% by weight of one or more of the mixed crystals of the invention.

Additionally present may be 0 to 20% by weight of an additional polymer (as “dye dissolver”), 0 to 5% by weight of dispersant, 0 to 20% by weight of viscosity modifier, 0 to 20% by weight of plasticizer, 0 to 10% by weight of tack additive, 0 to 10% by weight of transparency stabilizer (which prevents, for example, crystallization of the waxes), and 0 to 2% by weight of antioxidant.

The mixed crystals of the invention are additionally useful as colorants for color filters, both for additive and for subtractive color generation, and also as colorants for electronic inks (e-inks) or electronic paper.

The mixed crystals of the invention are also suitable for coloring seed.

The pigments of the invention are notable for high color strengths and very good light fastness and weather fastness properties. They contain no environmentally objectionable heavy metals. The properties enumerated qualify the pigments of the invention in particular for use as colorants in coating materials, preferably automotive finishes, and in plastics, and also in printing inks.

The term “parts” in the inventive and comparative examples below refers to parts by weight.

### COMPARATIVE EXAMPLES

### X═H

a) Synthesis as Per Patent DE 1 228 731 Example 4:

13.6 parts by weight of 1-aminobenzene-4-carboxamide are stirred together for some time with 60 parts by volume of 5 N hydrochloric acid. The mixture is then diluted with water and diazotized at 10° C. with 20 parts by volume of 5 N sodium nitrite solution. During the diazotization, 33 parts by weight of 1-(2′,3′-oxynaphthoylamino)-2-ethoxybenzene are dissolved hot with 450 parts by volume of water and 42 parts by volume of 5 N sodium hydroxide solution, and the resulting solution is clarified. This solution is run into the diazo solution over the course of 30 to 45 minutes at 10 to 15° C. with stirring, the diazo solution having been admixed beforehand with 7 parts by volume of glacial acetic acid and 50 parts by volume of 2 N sodium acetate solution. The resulting precipitate is isolated by suction filtration and washed. This produces the alpha phase of C.I. Pigment Red 170.

b) Synthesis and Finishing by a Method Based on DE 1 228 731 Example 4:

13.6 parts by weight of 1-aminobenzene-4-carboxamide are stirred together for some time with 60 parts by volume of 5 N hydrochloric acid. The mixture is then diluted with water and diazotized at 10° C. with 20 parts by volume of 5 N sodium nitrite solution. During the diazotization, 33 parts by weight of 1-(2′,3′-oxynaphthoylamino)-2-ethoxybenzene are dissolved hot with 450 parts by volume of water and 42 parts by volume of 5 N sodium hydroxide solution, and the resulting solution is clarified. This solution is run into the diazo solution over the course of 30 to 45 minutes at 10 to 15° C. with stirring, the diazo solution having been admixed beforehand with 7 parts by volume of glacial acetic acid and 50 parts by volume of 2 N sodium acetate solution. After the end of coupling, aqueous solutions of 5 parts by weight of resin soap and 3 parts by weight of calcium chloride are added in succession and the batch is boiled for 3 hours. The resulting precipitate is isolated by suction filtration and washed. This produces the beta phase of C.I. Pigment Red 170.

c) Finish as Per Patent DE 2 043 482 Example 1:

45 parts by weight of the pigment prepared in the comparative example (a) in the form of the aqueous filtercake are stirred with 1000 parts by weight of water, heated to a temperature of 130° C., and held at this temperature for 3 hours. The solid product is then isolated by filtration, washed with water, dried and pulverized. This gives C.I. Pigment Red 170 in the gamma phase.

### INVENTIVE EXAMPLE 1

### X═CH₃, 1%

Synthesis takes place as in the comparative example (a) but using as the amine, rather than 4-aminobenzamide, a mixture of 13.5 parts of 4-aminobenzamide and 0.15 part of 4-amino-3-methylbenzamide. This gives a mixed crystal isotypic with the alpha phase of P.R.170.

### INVENTIVE EXAMPLE 2

### X═CH₃, 10%

Synthesis takes place as in the inventive example 1 but using as the amine a mixture of 12.2 parts of 4-aminobenzamide and 1.5 parts of 4-amino-3-methylbenzamide. This gives a mixed crystal isotypic with the alpha phase of P.R.170.

### INVENTIVE EXAMPLE 3

### X═CH₃, 20%

Synthesis takes place as in the inventive example 1 but using as the amine a mixture of 10.9 parts of 4-aminobenzamide and 3.0 parts of 4-amino-3-methylbenzamide. This gives a mixed crystal isotypic with the alpha phase of P.R.170.

### INVENTIVE EXAMPLE 4

### X═CH₃, 40%

Synthesis takes place as in the inventive example 1 but using as the amine a mixture of 8.2 parts of 4-aminobenzamide and 6.0 parts of 4-amino-3-methylbenzamide. This gives a mixed crystal isotypic with the alpha phase of P.R.170.

### INVENTIVE EXAMPLE 5

### X═CH₃, 60%

Synthesis takes place as in the inventive example 1 but using as the amine a mixture of 5.4 parts of 4-aminobenzamide and 9.1 parts of 4-amino-3-methylbenzamide. This gives a mixed crystal isotypic with the alpha phase of P.R.170.

### INVENTIVE EXAMPLE 6

### X═CH₃, 80%

Synthesis takes place as in the inventive example 1 but using as the amine a mixture of 2.7 parts of 4-aminobenzamide and 12.1 parts of 4-amino-3-methylbenzamide. This gives a mixed crystal isotypic with the alpha phase of P.R.170.

### INVENTIVE EXAMPLE 7

### X═CH₃, 90%

Synthesis takes place as in the inventive example 1 but using as the amine a mixture of 1.4 parts of 4-aminobenzamide and 13.6 parts of 4-amino-3-methylbenzamide. This gives a mixed crystal isotypic with the alpha phase of P.R.170.

### INVENTIVE EXAMPLE 8

### X═CH₃, 99%

Synthesis takes place as in the inventive example 1 but using as the amine a mixture of 0.14 part of 4-aminobenzamide and 14.95 parts of 4-amino-3-methylbenzamide. This gives a mixed crystal isotypic with the alpha phase of P.R.170.

### INVENTIVE EXAMPLE 9

### X═CH₃, 10%, beta Phase

Synthesis takes place as in the comparative example (b) but using as the amine, rather than 4-aminobenzamide, a mixture of 12.2 parts of 4-aminobenzamide and 1.5 parts of 4-amino-3-methylbenzamide. This gives a mixed crystal isotypic with the beta phase of P.R.170.

### INVENTIVE EXAMPLE 10

### X═Cl, 10%

Synthesis takes place as in the comparative example (b) but using as the amine, rather than 4-aminobenzamide, a mixture of 12.2 parts of 4-aminobenzamide and 1.7 parts of 4-amino-3-chlorobenzamide. This gives a mixture of a mixed crystal of P.R.170 and Cl P.R. 170 that is isotypic with the beta phase of P.R. 170, and small fractions of a mixed crystal of P.R. 170 and Cl P.R. 170 that is isotypic with the gamma phase of P.R. 170.

### INVENTIVE EXAMPLE 11

### X=nitro, 10%

Synthesis takes place as in the comparative example (b) but using as the amine, rather than 4-aminobenzamide, a mixture of 12.2 parts of 4-aminobenzamide and 1.7 parts of 4-amino-3-nitrobenzamide. This gives a mixed crystal isotypic with the alpha phase of P.R.170.

### INVENTIVE EXAMPLE 12

### X═F, 10%

Synthesis takes place as in the comparative example (b) but using as the amine, rather than 4-aminobenzamide, a mixture of 12.2 parts of 4-aminobenzamide and 1.5 parts of 4-amino-3-fluorobenzamide. This gives a mixed crystal isotypic with the alpha phase of P.R.170.

### INVENTIVE EXAMPLE 13

### X═Br, 10%

Synthesis takes place as in the comparative example (b) but using as the amine, rather than 4-aminobenzamide, a mixture of 12.2 parts of 4-aminobenzamide and 2.15 parts of 4-amino-3-bromobenzamide. This gives a mixed crystal isotypic with the beta phase of P.R.170.

### INVENTIVE EXAMPLE 14

### X═CH₃, 10%, gamma Phase

Synthesis and finish take place as in the comparative example (c) but Using as the amine, rather than 4-aminobenzamide, a mixture of 12.2 parts of 4-aminobenzamide and 1.5 parts of 4-amino-3-methylbenzamide. This gives a mixed crystal isotypic with the gamma phase of P.R.170.

### INVENTIVE EXAMPLE 15

### X═Cl, 5%

Synthesis and finish take place as in the comparative example (c) but using as the amine, rather than 4-aminobenzamide, a mixture of 12.9 parts of 4-aminobenzamide and 0.85 part of 4-amino-3-chlorobenzamide. This gives a mixed crystal isotypic with the gamma phase of P.R.170.

### INVENTIVE EXAMPLE 16

### X=nitro, 10%

Synthesis and finish take place as in the comparative example (c) but using as the amine, rather than 4-aminobenzamide, a mixture of 12.2 parts of 4-aminobenzamide and 1.7 parts of 4-amino-3-nitrobenzamide. This gives a mixed crystal isotypic with the gamma phase of P.R.170.

### INVENTIVE EXAMPLE 17

### X═F, 10%

Synthesis and finish take place as in the comparative example (c) but using as the amine, rather than 4-aminobenzamide, a mixture of 12.2 parts of 4-aminobenzamide and 1.5 parts of 4-amino-3-fluorobenzamide. This gives a mixed crystal isotypic with the gamma phase of P.R.170.

### INVENTIVE EXAMPLE 18

### X═Br, 10%

Synthesis and finish take place as in the comparative example (c) but using as the amine, rather than 4-aminobenzamide, a mixture of 12.2 parts of 4-aminobenzamide and 2.15 parts of 4-amino-3-bromobenzamide. This gives a mixed crystal isotypic with the gamma phase of P.R.170.

### INVENTIVE EXAMPLE 19

### X═CH₃, 50%

Synthesis and finish take place as in the comparative example (c) but using as the amine, rather than 4-aminobenzamide, a mixture of 6.8 parts of 4-aminobenzamide and 7.6 parts of 4-amino-3-methylbenzamide. This gives a mixed crystal isotypic with the beta phase of P.R.170.

### EXAMPLE 20

### X═Cl, 5%, isobutanol Finish

Synthesis takes place as in the comparative example (a), using as the amine a mixture of 12.9 parts of 4-aminobenzamide and 0.85 part of 4-amino-3-chlorobenzamide. The pigment thus prepared, in the form of the aqueous filtercake, is stirred with 171 parts by weight of isobutanol and 65 parts by weight of water, heated to a temperature of 105° C. and held at this temperature for 1 hour. The solid product is subsequently isolated by filtration, washed with water, dried and pulverized. This gives a mixed crystal isotypic with the beta phase of P.R. 170.

### COUNTEREXAMPLE 1

### Isomeric amine with Cl, 10%

Synthesis takes place as in example 10, but replacing 4-amino-3-chlorobenzamide by 3-amino-4-chlorobenzamide. The product is not a mixed crystal, but instead a mixture of P.R.170 in the alpha phase, P.R.170 in the gamma phase, and the reaction product of diazotized 3-amino-4-chlorobenzamide and 1-(2′,3′-oxynaphthoylamino)-2-ethoxybenzene.

### COUNTEREXAMPLE 2

### Isomeric amine with methyl, 10%

Synthesis takes place as in example 9, but replacing 4-amino-3-methylbenzamide by 3-amino-4-methylbenzamide. The product is not a mixed crystal, but instead a mixture of P.R.170 in the gamma phase and the reaction product of diazotized 3-amino-4-methylbenzamide and 1-(2′,3′-oxynaphthoylamino)-2-ethoxybenzene.

### COUNTEREXAMPLE 3

### Isomeric amine with Cl, 10%

Synthesis takes place as in example 15, but using as the amine a mixture of 12.2 parts of 4-aminobenzamide and 1.7 parts of 3-amino-4-chlorobenzamide (instead of 4-amino-3-chlorobenzamide). The product is not a mixed crystal, but instead a mixture of P.R.170 in the γ phase, and the reaction product of diazotized 3-amino-4-chlorobenzamide and 1-(2′,3′-oxynaphthoylamino)-2-ethoxybenzene.

### COUNTEREXAMPLE 4

### Isomeric amine with methyl, 10%

Synthesis takes place as in example 14, but replacing 4-amino-3-methylbenzamide by 3-amino-4-methylbenzamide. The product is not a mixed crystal, but instead a mixture of P.R.170 in the gamma phase and the reaction product of diazotized 3-amino-4-methylbenzamide and 1-(2′,3′-oxynaphthoylamino)-2-ethoxybenzene.

### COUNTEREXAMPLE 5

### Physical Mixture

Synthesis and finish of methyl-P.R.170 take place as in the comparative example (c), but the amine used, instead of 4-aminobenzamide, is 15.1 parts of 4-amino-3-methylbenzamide. This gives a methyl-P.R.170 in the alpha phase. 10.3 parts of the dry pigment thus prepared are mixed thoroughly with 10 parts of P.R.170 from comparative example (c). This gives a physical mixture.

### APPLICATION EXAMPLES 1 TO 8

### Coloristics in Coating Materials

To assess the properties of the pigment phases prepared according to the invention in the coatings sector, a selection was made, from among the multiplicity of known coating materials, of an aromatics-containing alkyd-melamine resin varnish (AM) based on a medium-oil alkyd resin and on a butanol-etherified melamine resin. For better measurement of coloristics, white reductions were prepared, with a pigment: TiO₂ ratio of 1:10.

The hues are reported either visually or by the CIELAB system, with ΔH, ΔC, ΔL and ΔE being the difference in hue between the coating of the pigment and the coating of the product from the corresponding comparative example.

| | Pigment from | | | Coloristics of inventive example |
|---|---|---|---|---|
| Application | inventive | Comparative | | as compared with comparative |
| example | example | example | X = | example |
| 1 | 9 | b | methyl | masstone: trace lighter, trace |
| | | | | more hiding |
| | | | | reduction: |
| | | | | color strength 99%, ΔH = 0.86 |
| | | | | (yellower), ΔC = 0.70 (cleaner), |
| | | | | ΔL = 0.24 (lighter) |
| 2 | 10 | b | Cl | masstone: somewhat lighter, |
| | | | | somewhat more hiding |
| | | | | reduction: |
| | | | | color strength 89%, ΔH = 2.10 |
| | | | | (yellower), ΔC = −0.40 (dirtier), |
| | | | | ΔL = 0.11 (lighter) |
| 3 | 13 | b | Br | masstone: somewhat lighter, |
| | | | | somewhat yellower, somewhat |
| | | | | cleaner, somewhat more hiding |
| | | | | color strength 95%, ΔH = 1.88 |
| | | | | (yellower), ΔC = 0.78 (cleaner), |
| | | | | ΔL = 0.39 (lighter) |
| 4 | 14 | c | methyl | masstone: somewhat more |
| | | | | transparent, somewhat darker |
| | | | | reduction: |
| | | | | color strength 117%, trace darker |
| 5 | 15 | c | Cl | masstone: somewhat more |
| | | | | transparent |
| | | | | reduction: |
| | | | | color strength 108%, hue as (c) |
| 6 | 16 | c | nitro | masstone: somewhat more |
| | | | | transparent, somewhat darker |
| | | | | reduction: |
| | | | | color strength 99%, trace bluer |
| 7 | 17 | c | F | masstone: somewhat more |
| | | | | transparent, somewhat darker |
| | | | | reduction: |
| | | | | color strength 92%, trace dirtier |
| 8 | 18 | c | Br | masstone: somewhat more |
| | | | | transparent, somewhat darker |
| | | | | reduction: |
| | | | | color strength 109%, hue as (c) |

### APPLICATION EXAMPLES 9 TO 11

### Weather Fastness Properties

The pigments are dispersed in an aromatics-containing alkyd-melamine resin varnish (AM) based on a medium-oil alkyd resin and on a butanol-etherified melamine resin and are subjected to. weather fastness testing in the Weatherometer Cl5000 accelerated weathering apparatus. The tests took place in 1:10 white reduction. The weathering time was 500 hours. For assessment, the total coloristic difference ΔE (in the CIELAB system) was measured between the weathered and unweathered coatings. A smaller ΔE corresponds to better weather fastness.

| | Pigment | | Color |
|---|---|---|---|
| | from inventive | | difference |
| Application example | example | X = | ΔE |
| 9 | 9 | methyl | 10.9 |
| 10 | 10 | Cl | 8.1 |
| 11 | 13 | Br | 5.8 |
| Comparative (b) | (b) | H | 15.2 |
| Application counterexample 1 | Counterexample 1 | (isomer) | 23.8 |
| Application counterexample 2 | Counterexample 2 | (isomer) | 19.4 |

The pigments of the invention have substantially better weather fastness than the counterexample or comparative example prepared under the same conditions.

### APPLICATION EXAMPLES 12 TO 13

### Weather Fastness Properties

The pigments are dispersed in an aromatics-containing alkyd-melamine resin varnish (AM) based on a medium-oil alkyd resin and on a butanol-etherified melamine resin and are subjected to weather fastness testing in the Xenotest Beta X1200 accelerated weathering apparatus. The tests took place in masstone and in 1:10 white reduction. The weathering time was 1000 hours for the white reductions and 2000 hours in the masstone.

| | Pigment from | | | Color |
|---|---|---|---|---|
| Application | inventive | | | difference |
| example | example | X = | Masstone/reduction | ΔE |
| 12 | 15 | Cl | Masstone | 3.3 |
| Comparative | (c) | H | Masstone | 8.6 |
| 13 | 15 | Cl | Reduction | 5.6 |
| Comparative | (c) | H | Reduction | 6.3 |

The pigment of the invention has better weather fastness in masstone and in reduction than the comparative example prepared under the same conditions.

### APPLICATION EXAMPLE 14

### Light Fastness Properties, Reduction

The pigments are dispersed in an aromatics-containing alkyd-melamine resin varnish (AM) based on a medium-oil alkyd resin and on a butanol-etherified melamine resin and are subjected to a light fastness test in the Xenotest Beta X1200 accelerated exposure apparatus in parallel. The tests took place in 1:10 white reduction. The exposure time was 1500 hours.

| | Pigment from | | |
|---|---|---|---|
| Application example | inventive example | X = | Color difference ΔE |
| 14 | 14 | methyl | 6.7 |
| Comparative | (c) | H | 9.2 |
| Application | Counterexample 3 | (isomer) | 10.5 after |
| Counterexample 3 | | | 750 hours* |

*The exposure of the counterexample was terminated after 750 hours because the hue of the coating had already undergone severe alteration, whereas in the case of the other examples there was still no notable alteration apparent at this time.

The pigment of the invention had a markedly better light fastness than the comparative example prepared under the same conditions.

### APPLICATION EXAMPLES 15 AND 16

### Light Fastness, Masstone

The same procedure was used as for the light fastness testing in the preceding application examples, but the tests took place in the masstone. The exposure time was 2000 hours in parallel.

| | | | Color difference |
|---|---|---|---|
| Application example | Pigment from example | X = | ΔE |
| 16 | 17 | F | 2.6 |
| 17 | 18 | Br | 2.2 |
| Comparative | (c) | H | 3.0 |

The pigments of the invention have a somewhat better light fastness than the comparative example prepared under the same conditions.

### APPLICATION EXAMPLE 17

### Weather Fastness (50:50 Mixed Crystal)

The pigments are dispersed in an aromatics-containing alkyd-melamine resin varnish (AM) based on a medium-oil alkyd resin and on a butanol-etherified melamine resin and are subjected to weather fastness testing in the Xenotest Beta X1200 accelerated weathering apparatus. The tests took place in 1:10 white reduction. The weathering time was 1000 hours in parallel.

| | Pigment | | | Color |
|---|---|---|---|---|
| Application | from | | Crystal | difference |
| example | example | X = | phase | ΔE |
| 17 | 19 | CH₃ | beta + some | 7.5 |
| | | | gamma | |
| Comparative | (b) | H | beta | 14.9 |
| Comparative | (c) | H | gamma | 8.6 |
| Application | Counterexample 5 | CH₃/H | alpha(CH₃)/ | 20 |
| Counter- | | (physical | gamma(H) | |
| example 4 | | mixture) | | |

Despite being composed primarily of the beta phase, which for P.R.170 has a poorer light fastness, the pigment of the invention exhibits better light fastness than both comparative trials. The light fastness is much better than that of the physical mixture of the individual compounds prepared under the same conditions.

1. A mixed crystal of C.I. Pigment Red 170 and one or more compounds of the formula (1) 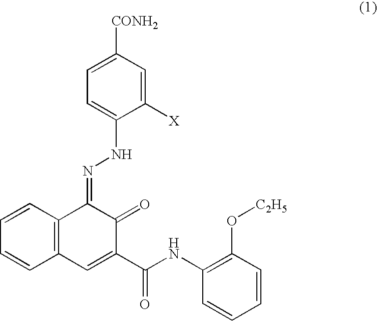
wherein
X is F, Cl, Br, methyl or nitro.

2. The mixed crystal as claimed in claim 1, containing between 0.1% and 99.9% by weight of C.I. Pigment Red 170 and between 99.9% and 0.1% by weight of at least one compound of the formula (1).

3. The mixed crystal as claimed in claim 1, containing between 1% and 99% by weight of C.I. Pigment Red 170 and between 99% and 1% by weight of at least one compound of the formula (1).

4. The mixed crystal as claimed in claim 1, containing between 80% and 99% by weight of C.I. Pigment Red 170 and between 20% and 1% by weight of at least one compound of the formula (1).

5. A mixed crystal as claimed in claim 1, wherein X is Cl or methyl.

6. The mixed crystal as claimed in claim 1, wherein the mixed crystal is isotypical with the alpha phase of C.I. Pigment Red 170.

7. The mixed crystal as claimed in claim 1, wherein the mixed crystal is isotypical with the beta phase of C.I. Pigment Red 170.

8. The mixed crystal as claimed in claim 1, wherein the mixed crystal is isotypical with the gamma phase of C.I. Pigment Red 170.

9. A process for preparing a mixed crystal as claimed in claim 1, comprising the step of coupling a mixture of diazotized 4-amino-1-benzenecarboxamide and at least one diazotized amine of the formula (2) 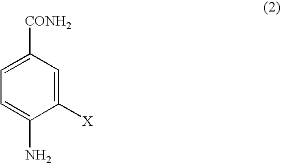
with a compound of the formula (3)

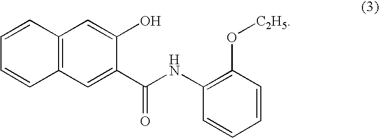

10. The process as claimed in claim 9, wherein 4-amino-1-benzenecarboxamide and at least one amine of the formula (2) are mixed and jointly diazotized, or are separately diazotized and the diazonium salts are subsequently mixed.

11. A process for preparing a mixed crystal as claimed in claim 1, comprising the step of coupling at least one diazotized amine of the formula (2) 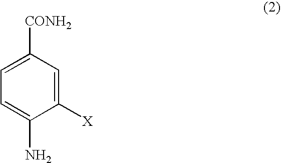
with a compound of the formula (3) 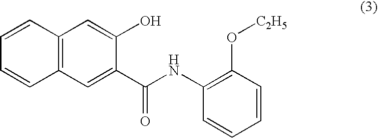
in the presence of C.I. Pigment Red 170.

12. A process for preparing a mixed crystal as claimed in claim 1, comprising the step of coupling diazotized 4-amino-1-benzenecarboxamide with a compound of the formula (3) 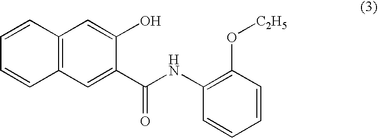
in the presence of at least one compound of the formula (1)

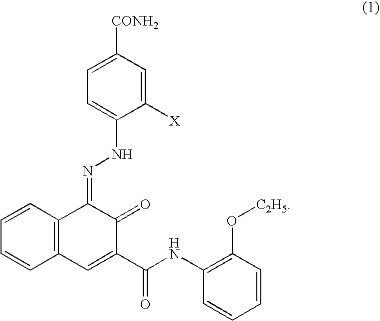

13. A process for preparing a mixed crystal as claimed in claim 1, comprising the steps of mixing C.I. Pigment Red 170 and at least one compound of formula (1) to form a mixture and subjecting the mixture to at least one of the treatment steps selected from the group consisting of of kneading, grinding, recrystallization, and heating in water and/or solvent, wherein the heating in water and/or solvent is, optionally, conducted under superatmospheric pressure.

14. The process as claimed in claim 13, wherein at least one of the steps is carried out in a microreactor.

15. A high molecular mass organic material of natural or synthetic origin pigmented with the mixed crystal as claimed in claim 1.

16. The high molecular mass organic material as claimed in claim 15, wherein the high molecular mass organic material is selected from the group consisting of plastics, resins, varnishes, paints electrophotographic toners, electrophotocraihic and developers, inks, printing inks, color filters and seed.

17. An automotive finish pigmented with a mixed crystal as claimed in claim 1.
